(19) United States
(12) Patent Application Publication
(10) Pub. No.: US 2016/0299654 A1
(43) Pub. Date: Oct. 13, 2016

(54) SPEED BUMP FOR CONFIRMING AD IMPRESSION IN A FEED

(71) Applicant: Flipboard, Inc., Palo Alto, CA (US)

(72) Inventors: Anh Mai, Palo Alto, CA (US); Charles Hugo Ying, San Mateo, CA (US); Evan Russell Doll, Menlo Park, CA (US)

(21) Appl. No.: 14/683,771

(22) Filed: Apr. 10, 2015

(51) Int. Cl. G06F 3/0485; G06F 3/0488; G06Q 30/02

(52) U.S. Cl. CPC G06F 3/0485; G06Q 30/0246; G06F 3/0488

(57) ABSTRACT

A client device displays a portion of a feed of content. The content feed is larger than a display area of the client device, and includes an ad not displayed within the display area. The client device receives a user input to scroll the content feed. In response to receiving the user input, the client device scrolls the content feed at a first rate while the ad is not displayed in the display area, and scrolls the content feed at a second rate while the ad is displayed within the display area of the client device.

### BACKGROUND

This disclosure relates generally to displaying advertisements in a feed of content items, and in particular to confirming impressions of advertisements in a content feed.

Providers of online content often incorporate advertisements into their content when distributing the content to users. In some cases, a display size of the content exceeds one or more dimensions of a display area of the client devices used to access the content. Accordingly, users may scroll the content displayed on a client device vertically or horizontally to view additional portions of the content not originally displayed. Content providers or advertisers often count an impression of an advertisement incorporated into online content if the advertisement is requested for display by a client device used by a user to access the content. However, as a user scrolls the content on a client device, the user may quickly scroll past an advertisement without carefully perusing it. Furthermore, the client device may retrieve an advertisement in an off-screen portion of the content that is not viewed by the user. It can therefore be difficult for an advertiser to assess whether a user has actually viewed an advertisement incorporated into online content.

### SUMMARY

A client device displays a portion of a feed content provided by an online content provider, such as a digital magazine server, where the feed includes an ad not displayed within the display area. The content feed is larger than a display area of the client device, and is scrollable vertically or horizontally on the client device to access additional portions of the content feed. When a user input to scroll the content feed is received at the client device, the client device scrolls the content feed at a first rate in response to the user input while the ad is not displayed within the display area, and scrolls the content feed at a second rate while the ad is displayed within the display area. The second rate may be a scrolling rate less than the first rate, and in one embodiment is a scrolling rate of zero. For example, after scrolling the content feed at a first rate defined by the user input, the client device slows or stops scrolling the content feed when the ad is displayed within the display area. By slowing or stopping the scrolling of the content feed, the client device increases the likelihood of the user viewing the ad while interacting with the content feed.

When the ad is displayed on the client device, the client device sends a notification of an impression of the ad to an ad server serving the ad. In one embodiment, the notification is sent responsive to scrolling the content feed at the second rate. In another embodiment, the notification is sent responsive to the ad being displayed within the display area for at least a threshold amount of time. Accordingly, an impression of the ad is counted when it is likely that a user has viewed the ad in the content feed.

The features and advantages described in this summary and the following detailed description are not all-inclusive. Many additional features and advantages will be apparent to one of ordinary skill in the art in view of the drawings, specification, and claims.

### BRIEF DESCRIPTION OF THE DRAWINGS

FIG. 1 is a block diagram of a system environment in which an online system operates, according to one embodiment.

FIG. 2 is a flowchart illustrating a method for confirming ad impressions in a content feed, according to one embodiment.

FIGS. 3A-C illustrate examples of a content feed including an advertisement.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A client device displays a feed of content items to users that includes one or more ads provided by an online system. As a user interacts with content of the online system via the client device, the client device monitors ads displayed to the user to track impressions of the ads. For example, a user scrolling content of the online system on the client device may scroll past an ad to view additional portions of the content. To confirm the user has viewed the ad (e.g., as opposed to quickly scrolling past the ad), the client device slows or stops scrolling of the content while the ad is displayed on the client device. As another example, the client device scrolls the content farther than requested by the user to display an ad that would otherwise not be displayed.

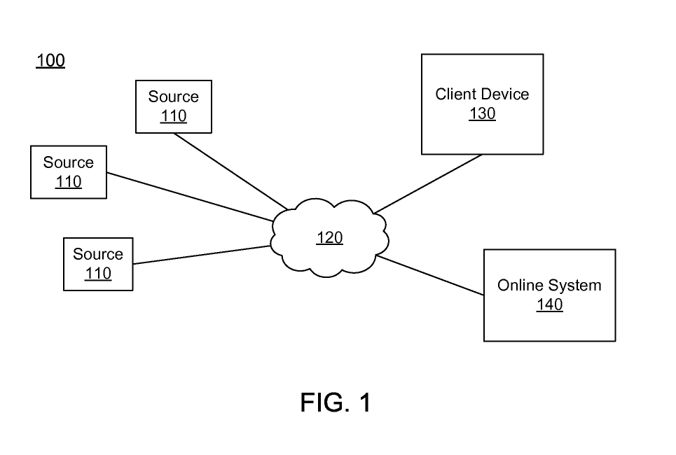

FIG. 1 is a block diagram of a system environment 100 for an online system 140 providing a feed of content items including an advertisement. The system environment 100 shown by FIG. 1 comprises one or more content sources 110, a network 120, a client device 130, and the online system 140. In alternative configurations, different and/or additional components may be included in the system environment 100. The embodiments described herein can be adapted to any of a variety of online systems, such as a digital magazine server, a social networking system, a news website, or an ad server.

A source 110 is a computing system capable of providing various types of content to a client device 130. Examples of content provided by a source 110 include text, images, video, or audio on web pages, web feeds, social networking information, messages, or other suitable data. Additional examples of content include user-generated content such as blogs, tweets, shared images, video or audio, social networking posts, and social networking status updates. Content provided by a source 110 may be received from a publisher (e.g., stories about news events, product information, entertainment, or educational material) and distributed by the source 110, or a source 110 may be a publisher of content it generates. For convenience, content from a source, regardless of its composition, may be referred to herein as an “article,” a “content item,” or as “content.” A content item may include various types of content, such as text, images, and video.

The sources 110 communicate with the client device 130 and the online system 140 via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

The client device 130 is one or more computing devices capable of receiving user input as well as transmitting and/or receiving data via the network 120. The client device 130 is a device having computer functionality, such as a personal digital assistant (PDA), a mobile telephone, a smartphone, or another suitable device, which 1 allows users to interact with the online system 140. The client device 130 retrieves pages of content from the online system 140 in response to user inputs received at the client device 130. While FIG. 1 shows a single client device 130, in various embodiments, any number of client devices 130 may communicate with the digital magazine server 140.

The online system 140 receives content items from one or more sources 110, generates a feed of the received content items, and provides the feed of content items to the client device 130. In one embodiment, the online system 140 is a digital magazine server generating a personalized, customizable digital magazine for a user based on the content retrieved from the sources 110. The generated digital magazine is retrieved by a digital magazine application executing on a client device 130 and presented to the user. For example, based on selections made by the user and/or on behalf of the user, the digital magazine server generates a digital magazine having one or more sections including content items retrieved from a number of sources and personalized for the user. The generated digital magazine allows the user to more easily consume content that interests and inspires the user by presenting content items in an easily navigable interface via a mobile computing device.

The digital magazine may be organized into a number of sections that each include content having a common characteristic (e.g., content obtained from a particular source). For example, a section of the digital magazine includes articles from an online news source (such as a website for a news organization), another section includes articles from a third-party-curated collection of content associated with a particular topic (e.g., a technology compilation), and an additional section includes content obtained from one or more accounts associated with the user and maintained by one or more social networking systems. For purposes of illustration, content included in a section is referred to herein as “content items” or “articles,” which may include textual articles, pictures, videos, products for sale, user-generated content (e.g., content posted on a social networking system), advertisements, and any other types of content capable of display within the context of a digital magazine.

### Ad Impressions in a Content Feed

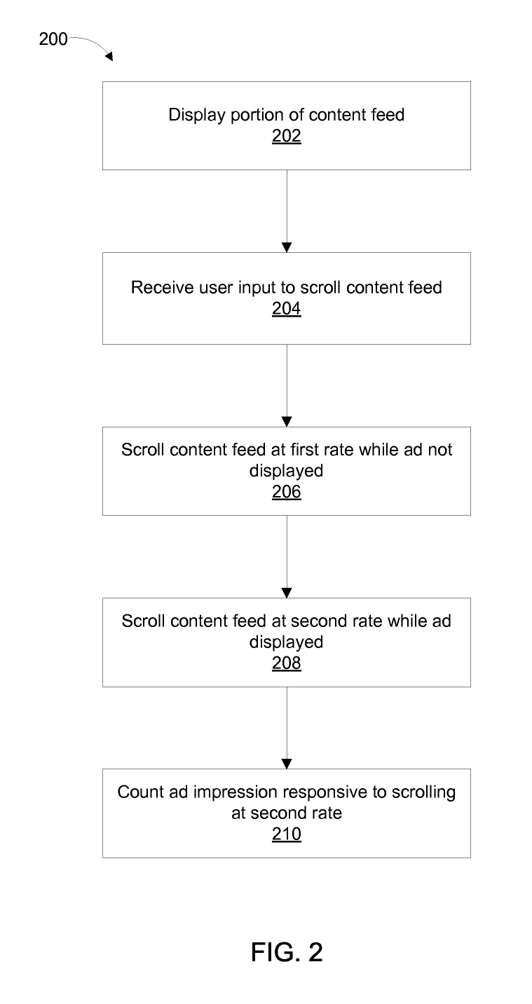

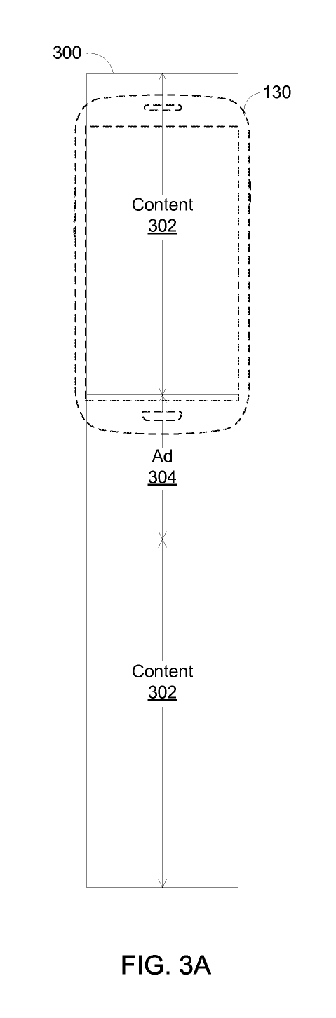

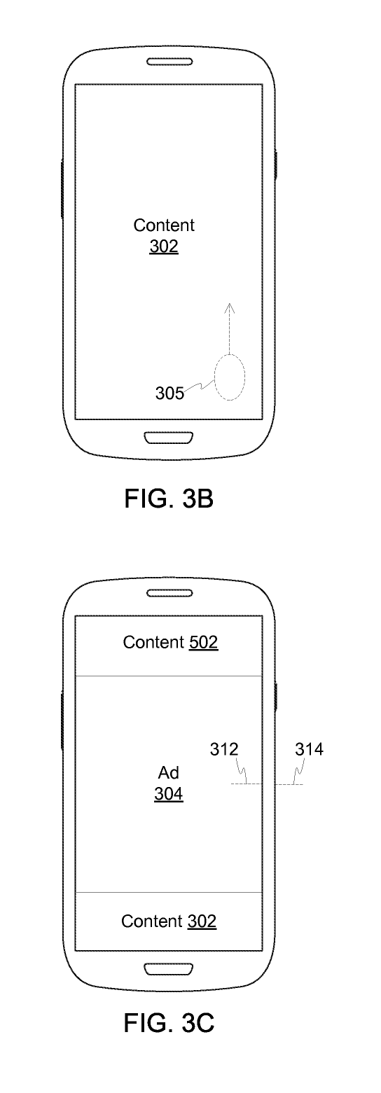

FIG. 2 is a flowchart illustrating a method 200 for confirming an ad impression in a content feed, according to one embodiment. In one embodiment, the steps of the process 200 are performed by the client device 130. Other embodiments include fewer, additional, or different steps, and may perform the steps in different orders. The process 200 is described with respect to an example feed 300 of content items shown in FIGS. 3A-C.

The client device 130 displays 202 a portion of a feed of content items. An example feed 300 of content items displayed by an example client device 130 is illustrated in FIG. 3A. As shown in FIG. 3A, the content feed 300 includes content 302 or identifiers of content items distributed by the online system 140, as well as one or more ads 304. The content feed 300 may include any type of digital content, such as a web page, an e-book, a social media feed, a photography gallery, or the like. For example, the content feed 300 includes a list of identifiers of articles of a digital magazine. Alternatively, the content feed 300 includes content of an article (or other type of content item) displayed by the client device 130.

The content feed may be larger than a display area of the client device 130. For example, the content feed 300 shown in FIG. 3A has a larger vertical dimension than the client device 130. Accordingly, the content feed 300 is scrollable vertically or horizontally (or both) to display off-screen content. For example, to view the ad 304 and additional portions of the content 302 on the example client device 130 shown in FIG. 3A, a user vertically scrolls the content feed 300 on the display of the client device 130.

Thus, while the content feed 300 is displayed on the client device 130, the client device 130 receives 204 a user input to scroll the content feed 300. FIG. 3B illustrates an example of scrolling the content feed 300 on a client device 130. In the example of FIG. 3B, the client device 130 is a device with a touchscreen display, such as a mobile phone or a tablet. The example user input 305 received at the client device 130 in FIG. 3B includes a continuous swipe gesture or a swipe gesture followed by a liftoff, in response to which the client device 130 scrolls the content feed 300. Other user inputs received 204 by the client device 130 may include a user selection of a scroll arrow or a user input at an arrow key or scroll wheel of an input device.

In response to receiving the user input, the client device 130 scrolls 206 the content feed 300 at a first rate while the ad 304 is not displayed within the display area of the device. In one embodiment, the client device 130 scrolls 206 the content feed 300 at a rate defined by the user input. For example, the client device 130 scrolls 206 the content feed 300 at a rate proportional to a rate of the user's swipe input across the display of the client device 130 or at a rate at which the user provides an input at a scroll arrow or arrow key. If the user input to scroll the content feed 300 is a swipe gesture followed by a liftoff, the client device 130 may continue scrolling the content feed 300 after the liftoff while decelerating the scrolling rate. The position in the content feed 300 to which the user input instructs the client device 130 to scroll is referred to herein as the instructed ending position. For example, if the user input is a continuous input and the client device 130 ceases scrolling the content feed 300 when the user input ends, the instructed ending position for scrolling the feed 300 is the position at which the user input ends. As another example, if the client device 130 continues scrolling the content feed 300 after the end of the user input (e.g., by decelerating the scrolling rate after detecting a liftoff), the instructed ending position for scrolling is the position in the feed at which the scrolling rate has been decreased to zero.

While the ad 304 or a portion of the ad 304 is displayed, the client device 130 scrolls 208 the content feed 300 at a second rate. In one embodiment, the second rate is a non-zero scrolling rate that is lower than the first rate. For example, if the user input 305 is an instruction to scroll from a position in the content feed 300 above the ad 304 to a position in the feed 300 below the ad 304, the client device 130 reduces the rate of scrolling from the first rate to the second rate in response to a top portion of the ad 304 moving onto the display. If the user continues scrolling to content below the ad, the client device 130 increases the rate of scrolling to the first rate after the ad 304 or a portion of the ad 304 has scrolled off the display. In another example, the client device 130 scrolls the content feed 300 at the second rate while at least a portion of the ad 304 is displayed within a specified region of the display of the client device 130 (e.g., a middle third of the display), and scrolls the content feed 300 at the first rate while the ad 304 is not displayed in the specified region.

In another embodiment, the client device 130 stops scrolling 208 the content feed 300 when the ad 304 is displayed (that is, the client device 130 scrolls the content feed 300 at a second scrolling rate of zero). FIG. 3C illustrates an example of the client device 130 ceasing to scroll the content feed 300 to statically display the ad 304. As an example, the user input 305 is an instruction to scroll beyond the ad 304 in the content feed 300. Rather than scrolling past the ad 304, the client device 130 ceases scrolling the content feed 300 when the ad 304 is displayed at a target position. For example, as shown in FIG. 3C, the client device 130 stops scrolling the content feed 300 when a center 312 of the ad 304 is displayed at a center line 314 of the display of the client device 130. In other examples, the client device 130 ceases scrolling the content feed 300 when a top of the ad 304 reaches a top of the display, when a bottom of the ad 304 reaches the bottom of the display, or when the ad 304 is displayed at another target position on the display. The client device 130 may decrease the rate at which the content feed 300 is scrolled as the ad 304 approaches the target position on the display. For example, if the content feed 300 is scrolled downward at a first rate before the ad 304 is displayed, the client device 130 begins decelerating the scrolling rate from the first rate to zero in response to a position in the content feed 300 a specified distance above the ad 304 being displayed at the target position. After the client device 130 scrolls the content feed 300 to display the ad 304, the user may provide a subsequent input to continue scrolling to a desired portion of the content 302.

Alternatively, if the user input 305 is an instruction to scroll to a position before the ad 304 in the content feed 300, the client device 130 scrolls the content feed 300 beyond the instructed ending position to display the ad 304. For example, the client device 130 continues scrolling the content feed 300 until the ad 304 is displayed at a specified location on the display, such as the center line 314, instead of scrolling to the instructed ending position. In one embodiment, the client device 130 scrolls the content feed 300 beyond the instructed ending position to display the ad 304 if the position in the feed at which the scrolling would end is less than a threshold distance from the ad 304. The client device 130 may scroll the content feed 300 from the instructed ending position to the ad 304 at a different rate than the first scrolling rate. For example, the client device 130 scrolls the content feed 300 at a rate faster than the first rate when scrolling from the instructed ending position to the ad 304. Alternatively, the client device 130 scrolls the content feed 300 from the instructed ending position to the ad 304 at the first scrolling rate.

In yet another embodiment, the client device 130 snaps the content feed 300 to the ad 304 by rapidly accelerating the scrolling rate of the content feed 300 after reaching the instructed ending position, and decelerating or stopping the scrolling rate of the content feed 300 when the ad 304 is displayed. For example, if the user input 305 is an instruction to scroll the content feed 300 beyond the ad 304, the client device 130 scrolls the content feed 300 to the instructed ending position, then reverses the scrolling direction and snaps the content feed 300 to the ad 304. As another example, if the user input 305 is an instruction to scroll to a position in the content feed 300 before the ad 304, the client device 103 rapidly scrolls the content feed 300 in the same direction as instructed by the user input 305 to snap the content feed 300 to the ad 304.

The client device 130 may determine whether to scroll 208 the content feed 300 at the second rate based on a type of user input to scroll the feed. In one embodiment, the client device 130 scrolls 208 the content feed 300 at the second rate responsive to the user input ending before the ad 304 is displayed. If the user input is continuously detected while the ad 304 is displayed on the client device 130, the client device 130 scrolls the content feed at the rate defined by the user input (e.g., the first rate). For example, as described above, the types of user inputs to scroll the content feed 300 on a client device 130 having a touchscreen display may be a swipe gesture with a liftoff or a continuous swipe gesture in which the user's finger does not lift off the display. In one embodiment, the client device 130 slows or stops the rate of scrolling of the content feed 300 when the ad 304 is displayed if the user input is a swipe gesture followed by a liftoff detected prior to the ad 304 being displayed at the target position. If the user's finger remains in contact with the touchscreen display while the ad 304 is displayed (e.g., if the user input to scroll the content feed 300 is a continuous swipe gesture), the client device 300 scrolls the content feed 300 at a rate specified by the user input. In another embodiment, the client device 130 scrolls the content feed 300 at a non-zero second scrolling rate if the user continues to provide the user input while the ad 304 is displayed, but ceases scrolling the content feed 300 if the user input has ended prior to the ad 304 being displayed.

After displaying the ad 304, the client device 130 counts 210 an impression of the ad 304 and sends a notification of the impression to an ad server serving the ad 304. In one embodiment, the client device 130 counts an impression of the ad 304 in response to slowing or stopping the rate of scrolling of the content feed 300. In another embodiment, the client device 130 counts an impression of the ad 304 if the ad 304 is displayed for at least a threshold amount of time. For example, if the client device 130 stops scrolling the content feed 300 when the ad 304 is displayed, the client device 130 counts 210 an impression if the user does not provide another input to continue scrolling the content feed 300 within a threshold amount of time.

By slowing or stopping scrolling of the content feed while an ad is displayed, the client device 130 facilitates an impression of the ad and increases the likelihood of a user viewing the ad. Furthermore, by counting an impression in response to slowing or stopping the scrolling of the content feed, the method 200 improves the accuracy of impression counts for ads displayed in a content feed. An accurate impression count received from the client device 130 enables the online system 140 or an advertising system to accurately calculate advertising costs, track ad analytics, and determine attributes for ad conversions, among other examples. For example, the online system 140 provides a cost-per-impression (CPM) advertising model, in which an advertiser is charged a specified amount per impression of the advertiser's ads in a content feed provided by the online system 140. Because the client device 130 counts an impression of an ad after slowing or stopping scrolling of the content feed to display the ad to a user, the advertiser is charged when the user is likely to have viewed the ad and is not charged when the ad is not displayed to the user.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
displaying a portion of a feed of content at a client device, the content feed larger than a display area of the client device and including an ad not displayed within the display area;
receiving a user input to scroll the content feed; and
responsive to receiving the user input:
scrolling the content feed at a first rate while the ad is not displayed in the display area of the client device, and
scrolling the content feed at a second rate while the ad is displayed in the display area of the client device.

2. The method of claim 1, further comprising:
responsive to scrolling the content feed at the second rate, sending a notification of an impression of the ad to an ad server serving the ad.

3. The method of claim 1, wherein the client device comprises a touchscreen display configured to receive the user input, the method further comprising:
detecting a liftoff from the touchscreen display after receiving the user input;
wherein the feed of content items is scrolled at the second rate responsive to detecting the liftoff.

4. The method of claim 1, wherein the content feed is scrolled at the first rate while the user input is provided.

5. The method of claim 1, further comprising:
transitioning from the first rate to the second rate responsive to scrolling a first portion of the ad onto the display area of the client device; and
transitioning from the second rate to the first rate responsive to scrolling a second portion of the ad off the display area of the client device.

6. The method of claim 1, wherein the second rate is lower than the first rate.

7. A method comprising:
displaying a first portion of a feed of content at a client device, the content feed larger than a display area of the client device and including an ad not displayed within the display area;
receiving a user input to scroll the content feed to display a second portion of the content feed, the second portion adjacent to the ad in the content feed; and
responsive to receiving the user input:
scrolling the content feed according to the first input; and
stopping the scrolling when the ad is displayed within the display area of the client device.

8. The method of claim 7, further comprising:
responsive to stopping the scrolling, sending a notification of an impression of the ad to an ad server serving the ad.

9. The method of claim 7, further comprising:
responsive to displaying the ad for at least a threshold amount of time after stopping the scrolling, sending a notification of an impression of the ad to an ad server serving the ad.

10. The method of claim 7, further comprising:
after scrolling the content feed according to the first input, scrolling the content feed at an accelerated rate until the ad is displayed within the display area.

11. The method of claim 7, wherein the scrolling is stopped when the ad is displayed responsive to determining the second portion of the content feed is less than a threshold distance from the ad.

12. The method of claim 7, wherein stopping the scrolling when the ad is displayed within the display area comprises scrolling beyond the second portion of the content feed to display the ad.

13. The method of claim 7, wherein the client device comprises a touchscreen display configured to receive the user input, the method further comprising:
detecting a liftoff from the touchscreen display after receiving the user input;
wherein the feed of content items is scrolled at the second rate responsive to detecting the liftoff.

14. The method of claim 7, wherein the scrolling is stopped to display an entirety of the ad within the display area of the client device.

15. The method of claim 7, wherein the scrolling is stopped to display the ad at a target position in the display area of the client device.

16. A non-transitory computer readable storage medium having instructions encoded thereon that, when executed by a processor, cause the processor to:
display a portion of a feed of content at a client device, the content feed larger than a display area of the client device and including an ad not displayed within the display area;
receive a user input to scroll the content feed; and
responsive to receiving the user input:
scroll the content feed at a first rate while the ad is not displayed in the display area of the client device; and
scroll the content feed at a second rate while the ad is displayed in the display area of the client device.

17. The non-transitory computer readable storage medium of claim 16, further comprising instructions that when executed by the processor cause the processor to:
responsive to scrolling the content feed at the second rate, send a notification of an impression of the ad to an ad server serving the ad.

18. The non-transitory computer readable storage medium of claim 16, wherein the client device comprises a touchscreen display configured to receive the user input, the computer program product further comprising instructions that when executed by the processor cause the processor to:
detecting a liftoff from the touchscreen display after receiving the user input;
wherein the feed of content items is scrolled at the second rate responsive to detecting the liftoff.

19. A non-transitory computer readable storage medium having instructions encoded thereon that, when executed by a processor, cause the processor to:
display a first portion of a feed of content at a client device, the content feed larger than a display area of the client device and including an ad not displayed within the display area;
receive a user input to scroll the content feed to display a second portion of the content feed, the second portion adjacent to the ad in the content feed; and
responsive to receiving the user input:
scroll the content feed according to the first input; and
stop the scrolling when the ad is displayed within the display area of the client device.

20. The non-transitory computer readable storage medium of claim 19, further comprising instructions that when executed by the processor cause the processor to send a notification of an impression of the ad to an ad server serving the ad responsive to displaying the ad for at least a threshold amount of time after stopping the scrolling.
